(19) United States
(12) Patent Application Publication
(10) Pub. No.: US 2018/0338419 A1
(43) Pub. Date: Nov. 29, 2018

(54) High Tensile Strength but Flexible Cutting Device

(71) Applicant: Dennis C. Simmons, SR., Overland Park, KS (US)

(72) Inventor: Dennis C. Simmons, SR., Overland Park, KS (US)

(21) Appl. No.: 15/603,364

(22) Filed: May 23, 2017

(51) Int. Cl. A01D 34/416

(52) U.S. Cl. CPC A01D 34/4168

(57) ABSTRACT

Utilizing embodiments comprised of atomic structures with superior tensile strength and compressibility such as carbon fiber; wrapped, molded, fused, or applied to a flexible embodiment; provides an embodiment that can still flex, but with superior reliability and safety. Plastic/nylon and similar embodiments rotating around an axis have little tensile strength and break apart as they hit objects. Carbon fibers or like materials; fused, molded, or applied to a rotating flexible embodiment add strength, while allowing it to still flex. Fusing, molding, wrapping, or applying intertwined fibers asymmetrically cancel torques as centrifugal forces try to straighten these flexible embodiments, leaving it a stronger embodiment. Intertwined fibers fused, molded, wrapped or applied asymmetrically to a flexible tube type embodiment create natural incremental weak/break points, automatically balancing around a rotating head, as well as to increase safety as the crossover points compress air, limiting flight of a broken off object.

This application claims the benefit of U.S. provisional No. 62/340,374 filed May 23, 2016 which is herein incorporated by reference.

### FIELD OF THE DISCLOSURE

The present disclosure relates to improvements in a cutting device/apparatus by increasing its tensile strength while still allowing it to retain the ability to flex or bend. For example, rotary cutting machines/devices utilizing rotating flexible tube type embodiments to cut materials can be significantly improved by increasing the tensile strength of the flexible tube type embodiment, but also allowing it to still bend as needed. Both safety and reliability can be improved.

### BACKGROUND OF THE INVENTION

The background description provided herein is for the purpose of generally presenting the context of the disclosure. Work of any named inventors, to the extent it is described in this background section, as well as aspects of the description that may not otherwise qualify as prior art at the time of filing, are neither expressly nor impliedly admitted as prior art against the present disclosure.

In the past, embodiments rotated around an axis to cut materials such as plant vegetation have been constructed of different types of plastic, nylon, and other materials to provide a safer material for cutting as well as the needed ability to flex. FIG. 1 (1) shows a relaxed typical flexible tube type embodiment. When this flexible tube type embodiment rotates around an axis, it creates the ability to cut material of different densities, depending on the revolutions per minute of the rotation about the axis, as well as the density and thickness of the material being cut. The centrifugal force created by this rotation straightens this flexible tube type embodiment FIG. 1 (2). When the embodiment hits an object such as a rock or stone FIG. 1 (3A), the mass of the stone can be great enough the tube type embodiment will bend and/or break apart at the location it hits the rock FIG. 1 (3B).

The problem with this is the plastic, nylon, or other material the flexible tube type embodiment is constructed of is very vulnerable to snapping off or breaking FIG. 1(4) when it hits an object such as the rock. This creates balance problems, safety problems, as well as the need to continue to replace the tube type embodiment. When a piece snaps off FIG. 1 (4A), it becomes a safety hazard.

In FIG. 1 (2), we have a typical straightened flexible tube type embodiment. And for this example, the outside diameter is 3 mm, and the length is 20 mm. FIG. 1 (5) shows a blown-up end view of this flexible tube type embodiment with numerous locations labeled 5A-5D; each with the objective of representing 90 degrees of a circle, or the end of the embodiment. When the flexible tube type embodiment is straight, each of these lengths is the same end to end for the full length of the embodiment, or 20 mm.

In FIG. 1 (3), we have a typical flexible tube type embodiment bent FIG. 1 (3B) as if it hit a rock. As you can see, parts of this flexible tube type embodiment have to either expand or contract (bend) because of the curvature. This expansion and contraction eventually breaks the typical flexible tube type embodiment apart.

If we were to measure the length of the embodiment for distances of the above (FIG. 1 (5A), FIG. 1 (5B), FIG. 1 (5C), FIG. 1 (5D)) end to end of the full length of the embodiment, we would find differences in them since parts of the embodiment have to compress or expand, both in length and width (diameter). The expansion is partially controlled by the tensile strength of the tube type material. As the material meets its tensile strength allowance (limit to elongation), the embodiment must compress at points along its axis, or expand or compress in width and/or diameter. Either of these eventually breaks the embodiment apart.

Additionally, as the rotation of the rotating cutting device increases in frequency (rotations per second), the centrifugal force applied to the flexible tube type embodiment stretches its atomic structure making it even more vulnerable to breaking off when hitting a stone or obstacle of a larger mass.

With carbon fiber or like materials having greater tensile strength than steel, and especially greater strength than the tensile strength of nylon, plastic, or other similar materials, the limits of the tensile strength of the carbon fiber are met before the limits of tensile strength of the material the embodiment is made of, and so the “stretching” of the material becomes limited, helping it to retain its shape longer and providing a safer and more reliable embodiment. And with carbon fiber or like materials having the unique ability to compress, flex or bend, it not only adds tensile strength stronger than steel, but also allows it to easily flex when hitting an object.

Other materials can be fused to a tube type embodiment to increase its tensile strength, but this is usually done at the cost of sacrificing bendability, compression, and safety. For example, in FIG. 1 (6), we have a reinforced tube type embodiment bent at location FIG. 1 (6A) with a thread of metal such as aluminum or steel fused FIG. 1 (7) or molded to it. As you can see, since this metal won't compress, the metal is forced to separate from the material FIG. 1 (6B). Over time, this metal weakens enough that it will separate from the tube type embodiment and project as a missile through the air. The present invention solves this problem taking advantage of the unique property of carbon fiber or like structures that do compress while having superior tensile strength.

FIG. 2 shows a typical rotary cutter device with two flexible tube type embodiments FIG. 2 (1) and FIG. 2 (2) for symmetry and balance connected to a rotating head FIG. 2 (3). For the rotating head to be vibration free, it needs to be balanced, meaning the flexible tube type embodiments need to be the same length, assuming they are the same type and thickness of material. If one flexible tube type embodiment breaks off, the rotating head embodiment the flexible tube type embodiments are attached to is left un-balanced. Providing a flexible tube type embodiment that would automatically break off at predefined points could assist in automatically balancing the device.

The present invention solves this problem by creating a flexible tube type embodiment with cross-over points along its axis in incremental locations FIG. 3 (1). Weak points are created by fusing, molding, or applying asymmetrically twisting carbon fiber or like materials to a flexible tube type embodiment.

When these fibers wrap an embodiment, they have crossover points (the strongest points on the axis), and orthogonal to these cross over points, are the weakest points along the axis. FIG. 3 (2) shows a blown-up view of the embodiment showing the weak points FIG. 3 (2A) and the strong points FIG. 3 (2B). These “weak points” are naturally created incrementally along the full length of the embodiment.

While the overall strength of the flexible tube type embodiment is greatly increased with the present invention, when a piece does become dislodged, the weak points by design become the default place to break off, creating a more balanced device as well.

As for safety, as the ends of tube type embodiments break apart, they can leave sharp ends flying off like a projectile missile. With the present disclosure, if the asymmetrical intertwined carbon fibers fused to the embodiment slightly protrude out from the surface of the embodiment, the v's that are formed at the crossover points try to compress the air as a piece is broken free and flowing through the air. Thus, these v's create resistance for the loose strand of the tube-type flowing through the air, limiting its flight and providing a safer environment.

Utilizing linear embodiments comprised of atomic structures with characteristics of superior tensile strength as well as compressibility such as carbon fiber; fused into a flexible tube type rotating embodiment, provides a flexible tube type embodiment having the ability to flex while cutting with superior strength, reliability, and safety.

Double helix intertwined carbon fiber strands can be fused into the embodiment as well along its axis creating resistance. Double helix fused, molded, or applied carbon fibers have the disadvantage over asymmetrical intertwined carbon fibers in that as centrifugal force is applied to the tube type embodiment, the strands of fiber try to straighten out, creating a torque on the inner atomic structure of the material the flexible tube type embodiment is made of, squeezing it and twisting it at the same time.

A double helix is a set of parallel helices intertwined about a common axis. With a double helix, both fibers are intertwined and parallel to each other along the axis of the embodiment, but never cross over each other, so they try to twist the embodiment as they straighten out from the centrifugal force. This places a torque on the embodiment.

Asymmetrical intertwined fibers are parallel to the axis of the embodiment, but orthogonal to each other and do cross over each other periodically.

### BRIEF SUMMARY OF THE INVENTION

The primary objective of the present invention is to provide an improved cutting device/apparatus for rotary cutting machines/devices.

Yet another objective of the present invention is to provide improved methods for creating an improved cutting device/apparatus for rotary cutting machines/devices.

### BRIEF DESCRIPTION OF THE DRAWINGS

For a more complete understanding of the disclosure, reference should be made to the following detailed description and accompanying drawing figures, in which like reference numerals identify like elements in the figures, and in which:

FIG. 1 illustrates an example flexible/bendable tube type embodiment;

FIG. 1 (1) illustrates a relaxed flexible tube type embodiment;

FIG. 1 (2) illustrates a straightened flexible tube type embodiment;

FIG. 1 (3) illustrates a bent flexible tube type embodiment;

FIG. 1 (3A) illustrates an example object such a rock;

FIG. 1 (3B) illustrates the location of a bend in a flexible tube type embodiment;

FIG. 1 (4) illustrates a flexible tube type embodiment with a broken off piece;

FIG. 1 (4A) illustrates a broken piece of a flexible tube type embodiment;

FIG. 1 (5) illustrates an enlarged view of the end of a flexible tube type embodiment;

FIG. 1 (5A-5D) illustrate locations at the end of an enlarged end view of a flexible tube type embodiment 90 degrees apart from each other;

FIG. 1 (6) illustrates a flexible tube type embodiment reinforced with a thread of metal;

FIG. 1 (6A) illustrates the example bend points of the flexible tube type embodiment;

FIG. 1 (6B) illustrates a thread of metal molded, fused, or wrapped to a flexible tube type embodiment broken away because of the inability to compress;

FIG. 2 illustrates a typical rotary head with two reinforced asymmetrical intertwined carbon fiber tube type embodiments attached;

FIG. 2 (1) illustrates the left side asymmetrical intertwined carbon fiber tube type embodiment;

FIG. 2 (2) illustrates the right side asymmetrical intertwined carbon fiber tube type embodiment;

FIG. 3 illustrates an example reinforced asymmetrical intertwined fused carbon fiber tube type embodiment;

FIG. 3 (1) illustrates a comprehensive view of a full length asymmetrical intertwined fused carbon fiber tube type embodiment with locations of “break points” and locations where the asymmetrical intertwined fused carbon fiber cross overs exist;

FIG. 3 (1A) illustrates the “weak” points along the axis of the asymmetrical intertwined carbon fiber tube type embodiment;

FIG. 3 (1B) illustrates points where the Intertwined carbon fibers crossover on the asymmetrical intertwined carbon fiber tube type embodiment;

FIG. 3 (2) illustrates an enlarged view of a reinforced asymmetrical intertwined carbon fiber tube type embodiment;

FIG. 3 (2A) illustrates the weak points of the reinforced asymmetrical intertwined carbon fiber tube type embodiment;

FIG. 3 (2B) illustrates the carbon fiber reinforced cross over points of the asymmetrical intertwined carbon fiber tube type embodiment.

FIG. 3 (3) illustrates a carbon fiber reinforced tube type embodiment with reinforcement parallel to the embodiment and not crossing over;

FIG. 3 (3A) illustrates the strands of carbon fiber reinforced tube type embodiment molded/fused parallel to the embodiment;

FIG. 3 (4) illustrates a blown-up view of a carbon fiber reinforced tube type embodiment with reinforcement parallel to the embodiment and not crossing over;

FIG. 3 (4A) illustrates the strands of carbon fiber reinforced tube type embodiment molded/fused parallel to the embodiment;

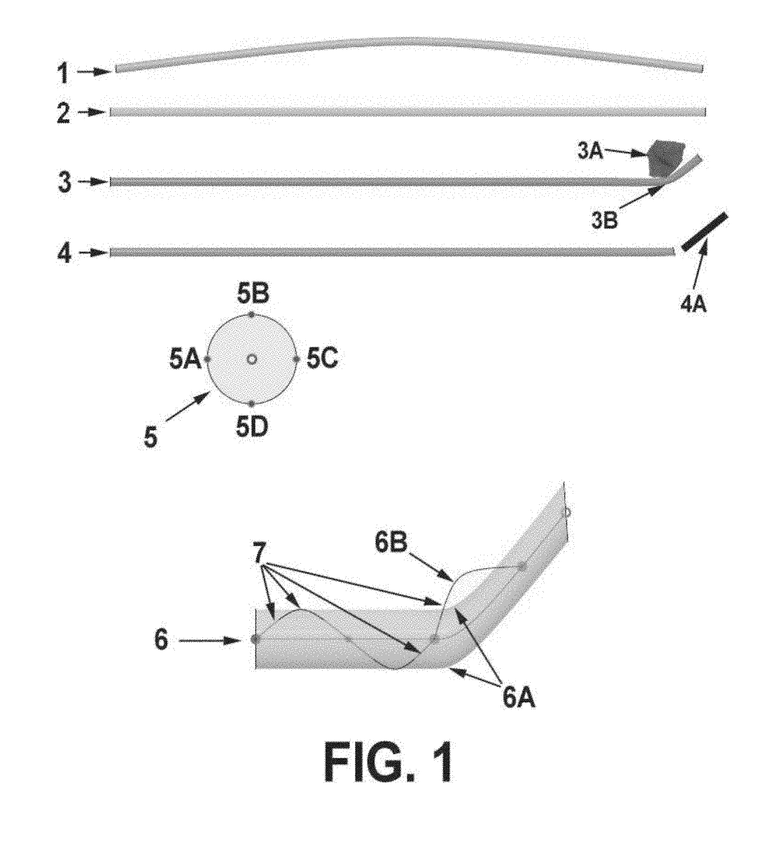

### DETAILED DESCRIPTION OF THE INVENTION

Hereinafter, embodiments of the present application are described in detail. However, these embodiments are exemplary, and this disclosure is not limited thereto.

The unique atomic structure of carbon fiber or other similar materials with superior tensile strength and an ease of compressibility, fused, molded, wrapped, or applied to a flexible tube type embodiment, increases the safety and reliability of the flexible tube type embodiments when used in cutting machines/devices. For this patent application, the term “tube type” is intended to include both hollow tubes, as well as solid tubes. Additionally, “tube type” is intended to include cylindrically formed devices as well linear formed devices with disproportional widths and overall dimensions. And while the words “carbon fiber” are used throughout this description, carbon fiber is intended to include carbon fiber or like materials with high tensile strength but the ability to also compress.

The superior tensile strength of carbon fiber or like materials resists elongation. And the unique ability for such materials to compress keeps internal structures that traditionally work against each other when trying to bend or flex, actually working with each other. The end result is an improvement in the reliability and safety of a flexible tube type embodiment.

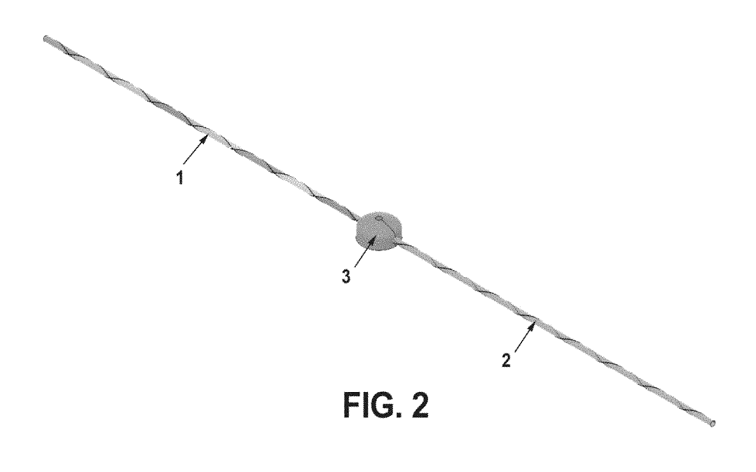

FIG. 2 shows two fibers such as carbon fiber intertwined and fused into a typical flexible tube type embodiment. In this case, the carbon fibers are intertwined equally in the number of twists per meter as well.

carbon fibers fused, molded, wrapped, or applied asymmetrically to a flexible tube type embodiment balance the “torques” applied to the axis of the embodiment as the centrifugal forces try to stretch it. With carbon fiber stretching at a different rate than the embodiment, if only one carbon fiber were fused into the tubular type embodiment, the tube type embodiment would try to rotate on its axis creating a “torque” propagating through its atomic structure. Adding fibers fused, molded, wrapped, or applied in the same direction yields the same result, such as the double helix. This torque would eventually break the embodiment apart, or at least weaken its internal structure. Having carbon fibers fused, molded, wrapped or applied and asymmetrically intertwined balances this torque.

Asymmetrical intertwined carbon fibers fused, molded, wrapped, or applied to a flexible tube type embodiment create torques of equal magnitude, but at angles opposite each other with respect to the axis of the embodiment. This applied torque tries to stretch the material of the tube type embodiment parallel to its axis as a centrifugal force is applied. As a rotary head spins, the centrifugal force causes the asymmetrical intertwined carbon fibers to stretch with respect to the tube type embodiment they are fused onto. Since they are intertwined onto the tube type embodiment, they will try to straighten as the centrifugal force is applied; much like a limp string when rotated around an axis becomes straight as long as it is spinning.

Additionally, since the carbon fibers are of a different atomic make-up than the tube-type material, when a centrifugal force is applied, their expansions will be at a different rate, creating another torque. That is, the expansions of the carbon fibers will be the same, but different than the tube-type material. When this happens, the asymmetrical or double helix intertwined wrapped carbon fibers actually try to squeeze the tube type embodiment together, making it smaller, stronger, and a more efficient cutter with a more concentrated mass. A smaller tube type embodiment with the more concentrated mass has to cut through less surface area, improving its efficiency.

Asymmetrically fused, molded, wrapped, or applied intertwined fibers and double helix fused, molded, wrapped, or applied intertwined fibers have a similar but different effect on the tube type embodiment as a centrifugal force is applied. Double helix fused, molded, wrapped, or applied embodiments place a squeezing, twisting and stretching torque on the tube type embodiment. Asymmetrically intertwined embodiments place a squeezing and stretching torque on the tube type embodiment, but not a twisting torque.

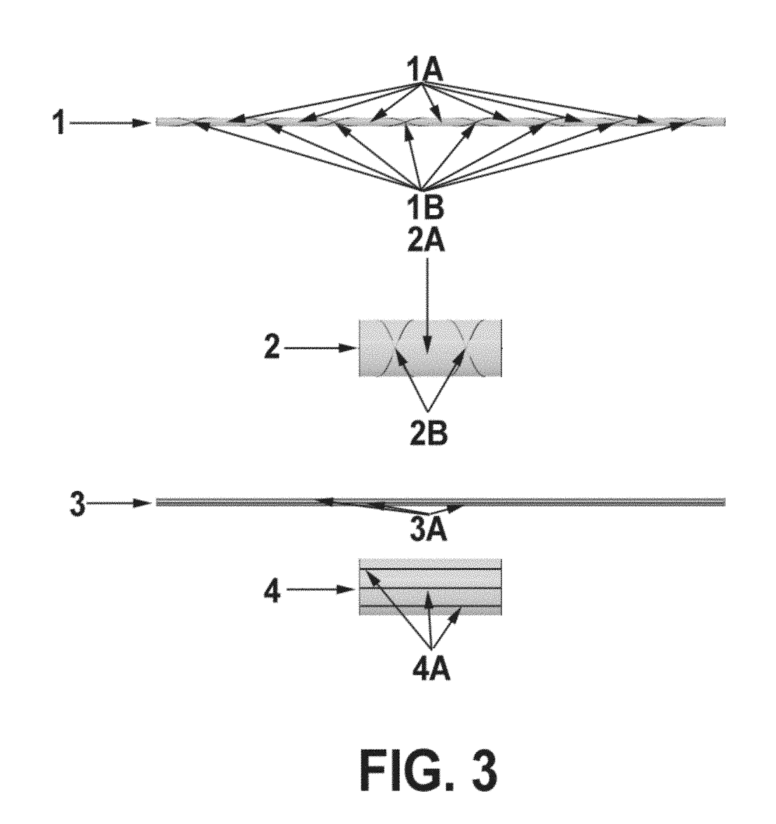

With asymmetrically intertwined embodiments, fusing, molding, wrapping, or applying the carbon fibers at the same number of twists per meter creates “break points” along the flexible tube type embodiment that are an equal distance from the rotary head. The incremental places the two carbon fibers or like material cross over (FIG. 3 (1B) and FIG. 3 (2B)) are the strong points of the reinforced flexible tube type embodiment, and the points orthogonal to these points, FIG. 3 (1A) and FIG. 3 (2A), are the weak points, naturally creating predictable incremental break points.

An alternative embodiment FIG. 3 (3) is to fuse carbon fibers or like materials parallel to the embodiment FIG. 3 (3A) that do not crossover. FIG. 4 shows a blown-up view of an embodiment with fused parallel carbon fibers FIG. 3 (4A).

With the present disclosure, if the asymmetrical intertwined carbon fibers fused to the embodiment slightly protrude out from the surface of the embodiment, the v's that are formed at the crossover points try to compress the air as a piece is broken free and flowing through the air. Thus, these v's create resistance for the loose strand of the tube-type flowing through the air, limiting its flight and providing a safer environment.

### Example

FIG. 2 shows a rotary apparatus/device with a rotating head FIG. 2 (3) and asymmetrical intertwined carbon fibers fused, molded, or applied to a flexible tube type embodiment (FIG. 2 (1) and FIG. 2 (2)).

What is claimed:

1. An apparatus enabling an embodiment to improve both its safety and reliability as a cutting device, the apparatus comprising:
a flexible tube type embodiment, whether solid or hollow, comprised of plastic, nylon, and/or other like materials with the ability to flex or bend;
with materials of an atomic structure of high tensile strength, yet compressible such as carbon fiber or like materials;
fused, molded, wrapped, or applied to the flexible tube type embodiment.

2. The apparatus of claim 1, wherein materials fused, molded, wrapped, or applied to the flexible tube type embodiment are asymmetrically intertwined along the axis of the flexible tube type embodiment, to focus/concentrate the mass of the flexible tube type embodiment as a centrifugal force is applied, providing for a more precise and efficient cutting embodiment.

3. The apparatus of claim 1, wherein materials fused, molded, wrapped, or applied to the flexible tube type embodiment are asymmetrically intertwined at equal points along the axis of the flexible tube type embodiment to create weak points for predictable breaks, balancing the mechanism when rotating in a rotating device.

4. The apparatus of claim 1, wherein materials fused, molded, wrapped, or applied to the flexible tube type embodiment are of a double helix to assist in the overall strength of the flexible tube type embodiment.

5. The apparatus of claim 1, wherein materials fused, molded, wrapped, or applied to the flexible tube type embodiment are parallel to the flexible tube type embodiment with no crossover points to assist in the overall strength of the flexible tube type embodiment.

6. The apparatus of claim 1, wherein materials fused, molded, wrapped, or applied to the flexible tube type embodiment are asymmetrically intertwined at equal points along the axis of the flexible tube type embodiment to create equal and opposite torques on the material of the embodiment as a centrifugal force is applied, cancelling the potential twisting or rotation of the embodiment along its axis, and making it stronger and more reliable.

7. The apparatus of claim 1, wherein materials fused, molded, wrapped, or applied to the flexible tube type embodiment are asymmetrically intertwined along the axis of the flexible tube type embodiment, fused, molded, wrapped, or applied in a way as to protrude from the surface, forming v's for air to compress as a piece is broken off; creating resistance to a flying object, limiting its distance, and providing for a safer cutting device.

8. A method enabling an embodiment to improve both its safety and reliability as a cutting device, the method comprising:
a flexible tube type embodiment, whether solid or hollow, comprised of plastic, nylon, and/or other like materials with the ability to flex or bend;
fusing, molding, wrapping, or applying to the flexible tube type embodiment;
materials of an atomic structure of high tensile strength, yet compressible such as carbon fiber or like materials.

9. The apparatus of claim 8, wherein materials fused, molded, wrapped, or applied to the flexible tube type embodiment are asymmetrically intertwined along the axis of the flexible tube type embodiment, to focus/concentrate the mass of the flexible tube type embodiment as a centrifugal force is applied, providing for a more precise and efficient cutting embodiment.

10. The apparatus of claim 8, wherein materials fused, molded, wrapped, or applied to the flexible tube type embodiment are asymmetrically intertwined at equal points along the axis of the flexible tube type embodiment to create weak points for predictable breaks, balancing the mechanism when rotating in a rotating device.

11. The apparatus of claim 8, wherein materials fused, molded, wrapped, or applied to the flexible tube type embodiment are of a double helix to assist in the overall strength of the flexible tube type embodiment.

12. The apparatus of claim 8, wherein materials fused, molded, wrapped, or applied to the flexible tube type embodiment are parallel to the flexible tube type embodiment with no crossover points to assist in the overall strength of the flexible tube type embodiment.

13. The apparatus of claim 8, wherein materials fused, molded, wrapped, or applied to the flexible tube type embodiment are asymmetrically intertwined at equal points along the axis of the flexible tube type embodiment to create equal and opposite torques on the material of the embodiment as a centrifugal force is applied, cancelling the potential twisting or rotation of the embodiment along its axis, and making it stronger and more reliable.

14. The apparatus of claim 8, wherein materials fused, molded, wrapped, or applied to the flexible tube type embodiment are asymmetrically intertwined along the axis of the flexible tube type embodiment, fused, or molded in a way to protrude from the surface forming v's for air to compress as a piece is broken off, creating resistance to a flying object, limiting its distance, and providing for a safer cutting device.
